(19) United States
(12) Patent Application Publication
(10) Pub. No.: US 2026/0028865 A1
(43) Pub. Date: Jan. 29, 2026

(54) FITTING FOR MOVABLY SUPPORTING A PIVOTING ELEMENT

(71) Applicant: Julius Blum GmbH, Hoechst (AT)

(72) Inventor: Alexander Simon FLOGAUS, Eriskirch (DE)

(21) Appl. No.: 19/350,632

(22) Filed: Oct. 6, 2025

Related U.S. Application Data
(63) Continuation of application No. PCT/AT2024/060078, filed on Mar. 1, 2024.

(30) Foreign Application Priority Data
Apr. 11, 2023 (AT) A 50255/2023

(51) Int. Cl. E05F 1/12

(52) U.S. Cl. CPC E05F 1/1253; E05Y 2201/422; E05Y 2900/20

(57) ABSTRACT

A fitting for movably supporting a pivoting element, in particular a movable furniture part, relative to a stationary structure, in particular a furniture carcass, includes a base body to be fixed to the stationary structure, an actuating arm to be connected to the pivoting element, and a spring device for applying a force to the actuating arm. The spring device is supported on the base body via a bearing device, and a transmission mechanism can transmit a force of the spring device to the actuating arm. The transmission mechanism includes a transmission lever pivotable about a hinge axis, and a force adjustment device for adjusting a force of the spring device to the actuating arm. The adjustment device, preferably separate from the force adjustment device, can adjust a position of the hinge axis of the transmission lever relative to the base body.

The present application is a continuation of International Application PCT/AT2024/060078 filed on Mar. 1, 2024. Thus, all of the subject matter of International Application PCT/AT2024/060078 is incorporated herein by reference.

### BACKGROUND OF THE INVENTION

The present invention relates to a fitting, configured as a furniture fitting or as a construction fitting, for movably supporting a pivoting element, in particular a movable furniture part, relative to a stationary structure, in particular a furniture carcass, the fitting comprising:
at least one base body configured to be fixed to the stationary structure,
at least one actuating arm configured to be connected to the pivoting element,
at least one spring device for applying a force to the at least one actuating arm, the spring device being supported on the at least one base body via at least one bearing device,
at least one transmission mechanism for transmitting a force of the at least one spring device to the at least one actuating arm, the transmission mechanism including at least one transmission lever pivotable about a hinge axis,
at least one force adjustment device for adjusting a force of the spring device to the at least one actuating arm.

Further, the invention concerns an item of furniture comprising a stationary structure, in particular a furniture carcass, at least one pivoting element, in particular a movable furniture part, movably supported relative to the stationary structure, and at least one fitting of the type to be described for moving the pivoting element relative to the stationary structure.

WO 2006/005086 A1 discloses a furniture drive for moving a furniture flap, in which a pivotally supported actuating arm is pre-stressed by a spring device so as to compensate for a weight force of the furniture flap. The spring device is hingedly connected to an intermediate lever via an adjustable engagement location, and the intermediate lever can pivot the actuating arm via an arrangement comprising a pressure roller and a control curve. By an adjustment of the engagement location along the intermediate lever, a pre-stressing force of the spring device is variable so as to compensate for different weights of a pivoting element connected to the actuating arm.

The block-length of the spring (that is to say the length of the spring in a fully compressed condition), limits the force of the spring device. For heavier furniture flaps, spring devices with a larger spring force must be provided. However, the larger spring force leads to the fact that the movable furniture part, in a closed position with respect to the furniture carcass, is also pressed against the furniture carcass with a larger retracting force. An operator has to overcome this retracting force upon each opening procedure by manually applying a pulling force to the movable furniture part. As a result, an increased force effort is required, and this is frequently considered as disturbing by the operator.

### SUMMARY OF THE INVENTION

It is an object of the present invention to propose a fitting of the type mentioned in the introductory part, thereby avoiding the above-discussed drawbacks.

According to the invention, at least one adjustment device, preferably separate from the at least one adjustment device, is provided for adjusting a position of the at least one hinge axis of the at least one transmission lever relative to the base body.

In other words, the fitting also includes, besides the force adjustment device, also an adjustment device configured to adjust a position of the hinge axis of the at least one transmission lever relative to the base body. In this way, the kinematics of the transmission mechanism can be altered such that a stronger, in particular a longer, spring device can be used by default, without substantially varying the retraction force of the actuating arm in the closed position. Accordingly, with the construction according to the invention, a broader spectrum of different weights of the pivoting element can be covered.

According to a first variant of the invention, the at least one force adjustment device and the at least one adjustment device include a common adjustment element or at least two motionally coupled adjustment elements, preferably motionally coupled via at least one tooth arrangement. By the common adjustment element or by the at least two motionally coupled adjustment elements, the force of the spring device to the at least one actuating arm and the position of the at least one hinge axis of the at least one transmission lever relative to the base body are simultaneously adjustable.

According to a second variant of the invention, the at least one force adjustment device and the at least one adjustment device include two mutually independent adjustment elements. The force of the spring device to the at least one actuating arm and the position of the at least one hinge axis of the at least one transmission lever relative to the base body are independently adjustable of one another by the two adjustment elements.

The item of furniture according to the invention comprises a stationary structure, in particular a furniture carcass, at least one pivoting element, in particular a movable furniture part, movably-supported relative to the stationary structure, and at least one fitting of the type in question for moving the pivoting element relative to the stationary structure.

The pivoting element can be pivotally supported about at least one horizontally or a vertically extending pivoting axis, and/or the fitting according to the invention includes such a pivoting axis.

For example, the pivoting element can be a pivoting door or a flap, for example an upwardly liftable flap, an upwardly pivotable flap, or an upwardly movable folding flap.

The fitting is not only applicable as a furniture fitting for moving a movably-supported furniture part, but advantageously also as a construction fitting for moving windows or doors.

### BRIEF DESCRIPTION OF THE DRAWINGS

Further details and advantages of the present invention will be apparent from the following description with reference to the drawings, in which:

FIG. 1a, 1b are perspective views of an item of furniture comprising a movably-supported furniture part and a fitting for moving the movable furniture part,

FIG. 2a, 2b show an embodiment of a fitting in a closed position and in an open position,

FIG. 3a, 3b show the embodiment of the fitting according to FIGS. 2a, 2b with an altered position of the spring device and with an altered position of the hinge axis of the transmission lever relative to the base body, FIG. 4a-4d show a further embodiment of a fitting with two adjustment elements coupled to each other,

FIG. 5a-5d show a further embodiment of a fitting with a guide track for displaceably supporting the hinge axis of the transmission lever, show a further embodiment of a fitting with a force adjustment FIG. 6a-6d device and with an adjustment device independent from the force adjustment device for adjusting a position of the hinge axis relative to the base body, and

FIG. 7a, 7b show a further embodiment of a fitting, in which the transmission mechanism includes at least one arrangement comprising a pressure roller and a control curve for pivoting the actuating arm.

### DETAILED DESCRIPTION OF THE INVENTION

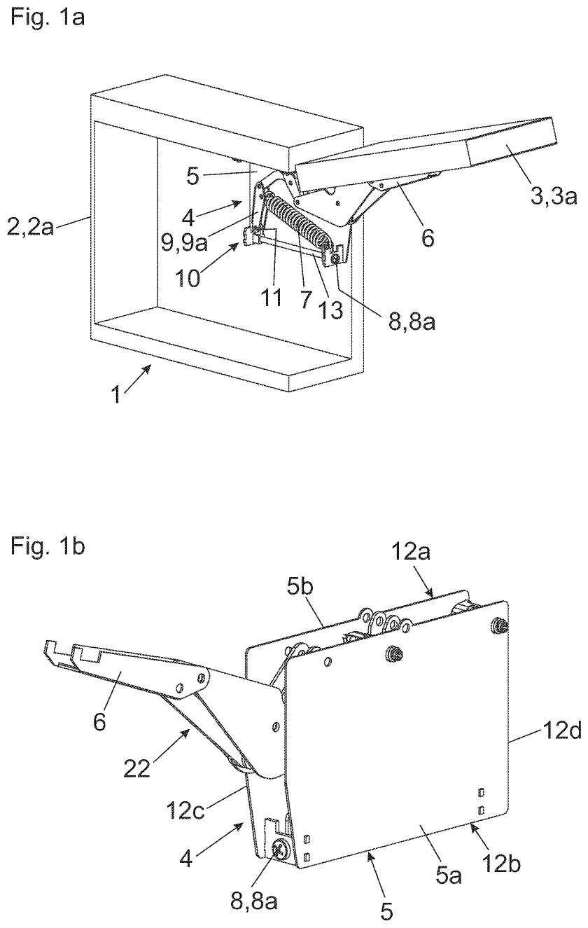

FIG. 1a shows an item of furniture 1 comprising a stationary structure 2, in particular a furniture carcass 2a, and a pivoting element 3 movably-supported relative to the stationary structure 2. Preferably, the pivoting element 3 is a movable furniture part 3a in the form of a furniture flap to be lifted relative to the stationary structure 2.

The pivoting element 3 is movably supported relative to the stationary structure 2 via at least one fitting 4. The fitting 4 includes at least one base body 5 configured to be fixed to the stationary structure 2, at least one actuating arm 6 configured to be connected to the pivoting element 3, and at least one spring device 7 for applying a force to the at least one actuating arm 6.

For example, the spring device 7 can include at least one helical spring, preferably a plurality of helical springs. In the shown embodiment, the spring device 7 includes at least one tension spring. As an alternative or in addition, the spring device 7 can include at least one gas pressure spring.

The fitting 4 further includes at least one transmission mechanism 9 for transmitting a force of the at least one spring device 7 to the at least one actuating arm 6, the transmission mechanism 9 including at least one transmission lever 9a pivotable about a hinge axis 11.

By at least one force adjustment device 8, a force of the spring device 7 to the at least one actuating arm 6 is adjustable.

In the shown embodiment, the force adjustment device 8 includes at least one rotationally supported adjustment element 8a, and a force of the spring device 7 to the at least one actuating arm 6 is adjustable by rotating the adjustment element 8a.

The adjustment element 8a can be configured for manual actuation or for an actuation with the aid of a tool, for example for a screwdriver.

Further, the fitting 4 includes at least one adjustment device 10 for adjusting a position of the at least one hinge axis 11 of the at least one transmission lever 9a relative to the base body 5.

According to a possible embodiment, the force adjustment device 8 and the adjustment device 10 are coupled to each other such that upon an actuation of the force adjustment device 8, the position of the hinge axis 11 of the transmission lever 9a relative to the base body 5 is also adjustable (or vice versa).

FIG. 1b shows the fitting 4 in a perspective view. The base body 5 to be fixed to the stationary structure 2 includes two housing walls 5a, 5b spaced apart from each other substantially in a parallel relationship, and each of the housing walls 5a, 5b is configured to bear against the stationary structure 2.

The base body 5 has an upper side 12a and a lower side 12b which are aligned substantially horizontally in a mounted condition of the fitting 4.

The fitting 4 includes a lever mechanism 22 having at least five, preferably at least seven, hinge axes, by which the at least one actuating arm 6 is movably supported on the base body 5.

By the force adjustment device 8, a pre-stressing force of the at least one spring device 7 is adjustable so as to compensate for different weights of a pivoting element 3 to be connected to the actuating arm 6.

At least one of the provided adjustment elements 8a includes at least one threaded spindle 13 (FIG. 1a) or is connected to at least one threaded spindle 13 in a motionally-coupled manner, and/or is directly accessible for an actuation from a front side 12c, 12d of the fitting 4, and/or is aligned obliquely to the upper side 12a and/or obliquely to the lower side 12b of the at least one base body 5.

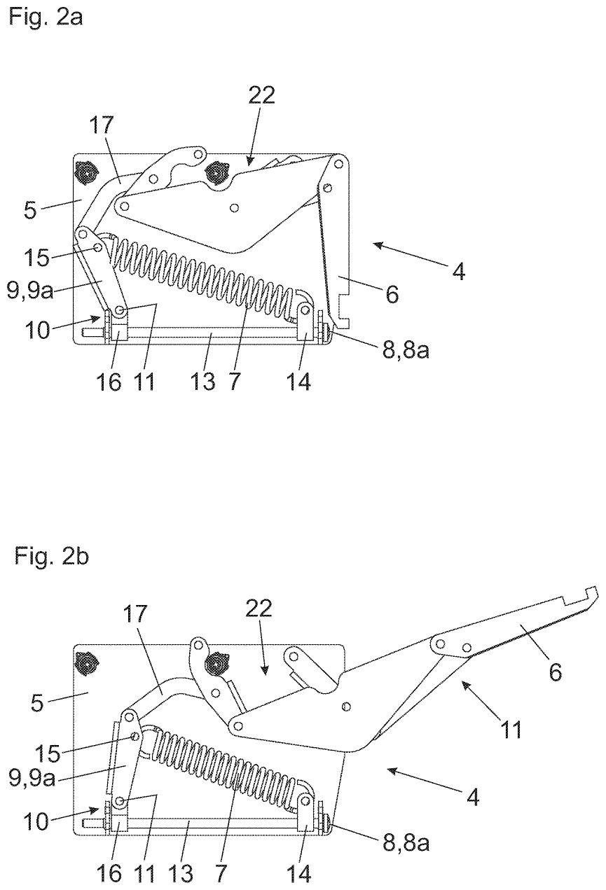

FIG. 2a shows an embodiment of a fitting 4 located in a closed position.

At least one actuating arm 6 to be connected to the pivoting element 3, at least one spring device 7 for applying a force to the at least one actuating arm 6, and a transmission mechanism 9 having at least one transmission lever 9a are arranged on the base body 5.

By the force adjustment device 8, a torque from the at least one spring device 7 acting onto the actuating arm 6 is adjustable. In this way, different weights of the pivoting element 3 can be at least partially compensated for, so as to facilitate the movement of the pivoting element 3 for an operator. The spring device 7 is movably supported on the at least one base body 5 via at least one bearing device 14.

The force adjustment device 8 includes at least one, preferably rotationally supported, adjustment element 8a, and a position of the bearing device 14 relative to the base body is adjustable, preferably along a threaded spindle 13, by an actuation, preferably by a rotation, of the at least one adjustment element 8a.

The spring device 7 is connected to the at least one transmission lever 9a via an engagement location 15.

In the shown embodiment, the engagement location 15 is arranged so as to be stationary relative to the transmission lever 9a, and/or is spaced apart from the hinge axis 11 of the at least one transmission lever 9a.

The at least one transmission lever 9a has a first end and a second end, and the hinge axis 11 of the transmission lever 9a is arranged on the first end. On the second end of the transmission lever 9a, at least one force transmitting element 17 pressurized by the spring device 7 is arranged. Preferably, the force transmitting element 17 can be a lever, a pressure portion, a pressure roller or a control curve.

In the shown embodiment, the force transmitting element 17 is in the form of a, preferably curved, lever which is hingedly connected to the transmission lever 9a on the one hand, and which is hingedly connected to the lever mechanism 22 on the other hand.

The lever mechanism 22 can include at least five, preferably at least seven, hinge axes. In this way, the at least one actuating arm 6 can be stably guided between a closed position and an open position.

In the shown figure, the engagement location 15 of the spring device 7 is arranged between the first end and the second end of the transmission lever 9a.

According to an embodiment, at least one bearing device 14, 16 for supporting the spring device 7 and/or for supporting the at least one hinge axis 11 on the base body 5 is or are provided. A position of the bearing device 14, 16 relative to the base body 5 is adjustable by the at least one force adjustment device 8 and/or by the at least one adjustment device 10.

According to a further embodiment, a first bearing device 16 for supporting the at least one hinge axis 11 and a second bearing device 14 for supporting the spring device 7 are provided. Preferably, the two bearing devices 14, 16 are movably arranged on a common threaded spindle 13, or on two threaded spindles 13, 13a motionally coupled to each other, preferably motionally coupled via at least one tooth arrangement 19a, 19b (FIG. 4a-4d), or on two mutually independent threaded spindles 13, 13a.

Preferably, by an actuation of the force adjustment device 8, a position of the bearing device 14 of the spring device 7 as well as a position of the hinge axis 11 of the at least one transmission lever 9a relative to the base body 5 is adjustable.

The at least one actuating arm 6 is movably supported between a closed position and an open position, and by the adjustment of the position of the at least one transmission lever 9a, a closing force, that can be applied to the actuating arm 6 in the closed position by the spring device 7, is adjustable.

FIG. 2b shows the fitting 4 illustrated in FIG. 2a with the actuating arm 6 in an open position.

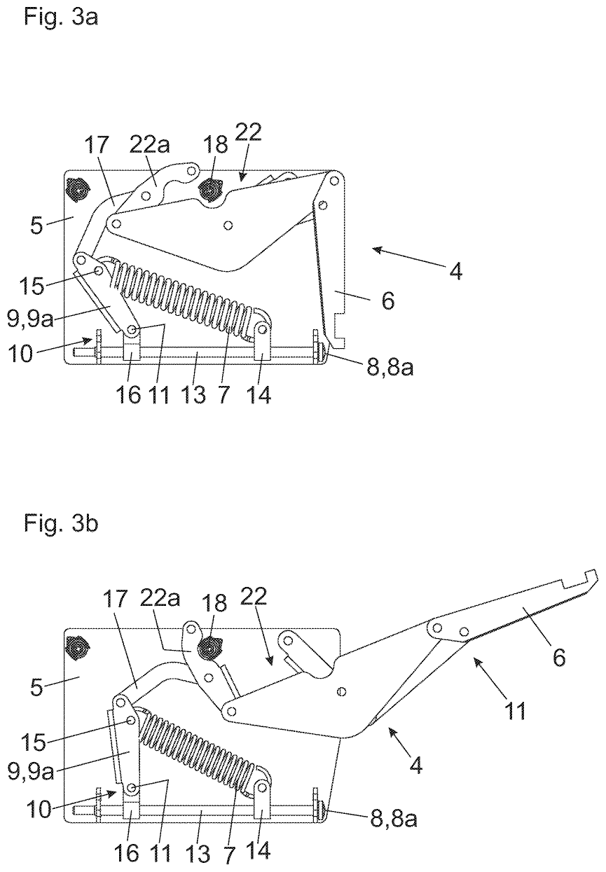

FIG. 3a shows the fitting 4 according to FIGS. 2a, 2b in the closed position. When the force adjustment device 8 is actuated, both a position of the bearing device 14 of the spring device 7 and a position of the hinge axis 11 of the transmission lever 9a relative to the base body 5 of the fitting 4 is adjustable.

In a direct comparison with FIG. 2a, 2b, the spring device 7 is tensioned to a lesser extent, so that this adjustment is to be provided for lighter weights of the pivoting element 3.

The spring device 7 can thus be stronger dimensioned by default, so that heavier weights of the pivoting element 3 can also be compensated for. In order that the stronger spring device 7 does not lead to a substantial increase of the closing force applied to the actuating arm 6, the position of the hinge axis 11 of the at least one transmission lever 9a relative to the base body 5 has also been altered.

FIG. 3b shows the fitting 4 according to FIG. 3a in an open position, in which a lever 22a of the lever mechanism 22 bears against at least one abutment 18 so as to limit the maximum open position of the at least one actuating arm 6.

The at least one abutment 18 can be arranged on the base body 5 and/or can be configured to be adjustable, so that the maximum open position of the at least one actuating arm 6 is adjustable by an actuation, preferably by a rotation, of the at least one abutment 18. By limiting the maximum open position of the actuating arm 6, collisions between the pivoting element 3 and a room ceiling can be prevented.

FIG. 4a-4d show a further embodiment of a fitting 4 with two adjustment elements 8a, 10a coupled to each other.

FIG. 4a shows the fitting 4 in a closed position of the actuating arm 6, in which the spring device 7 is maximally tensioned. Accordingly, with this adjustment, the weight force of heavy pivoting elements 3 can be compensated for, and the hinge axis 11 of the transmission lever 9a adopts a first position relative to the base body 5.

The force adjustment device 8 for adjusting a torque of the spring device 7 acting on the actuating arm 6 includes a first, preferably rotatable, adjustment element 8a.

The adjustment device 10 for adjusting a position of the hinge axis 11 of the at least one transmission lever 9a relative to the base body 5 includes a second, preferably rotatable, adjustment element 10a.

The spring device 7 is movably supported along a first threaded spindle 13 via a first bearing device 14. The hinge axis 11 of the at least one transmission lever 9a is movably supported along a second threaded spindle 13a via a second bearing device 16.

The two adjustment elements 8a, 10a are connected to each other in a movement-coupled manner, preferably via at least one tooth arrangement 19a, 19b. By the adjustment elements 8a, 10a connected to each other in a movement-coupled manner, the force of the spring device 7 to the at least one actuating arm 6 and the position of the at least one hinge axis 11 of the at least one transmission lever 9a relative to the base body 5 are simultaneously adjustable. For example, the two tooth arrangements 19a, 19b can be configured as bevel gears meshing with each other.

Alternatively, at least one torque-transmitting joint, for example a cardan joint, can be provided for coupling a rotational movement between the two adjustment elements 8a, 10a.

FIG. 4b shows the fitting 4 according to FIG. 4a in an open position of the at least one actuating arm 6.

FIG. 4c shows the fitting 4 in the closed position of the actuating arm 6, in which the spring device 7, in a direct comparison with FIG. 4a, 4b, is tensioned to a lesser extent. Accordingly, with this adjustment, the weight of lighter pivoting elements 3 can be compensated for, and the hinge axis 11 of the transmission lever 9a adopts a second position relative to the base body 5.

The second position of the hinge axis 11 of the transmission lever 9a according to FIG. 4c deviates from the first position of the hinge axis 11 of the transmission lever 9a according to FIG. 4a.

Upon an actuation of an adjustment element 8a, 10a, the other adjustment element 10a, 8a is also moved therewith, and the bearing devices 14, 16 are movable along the threaded spindles 13, 13a upon rotating an adjustment element 8a, 10a.

Each of the bearing devices 14, 16 can include an inner thread which is in engagement with the threaded spindles 13, 13a, or which is configured to be engaged with the threaded spindles 13, 13a.

FIG. 4d shows the fitting 4 according to FIG. 4c with the at least one actuating arm 6 located in an open position.

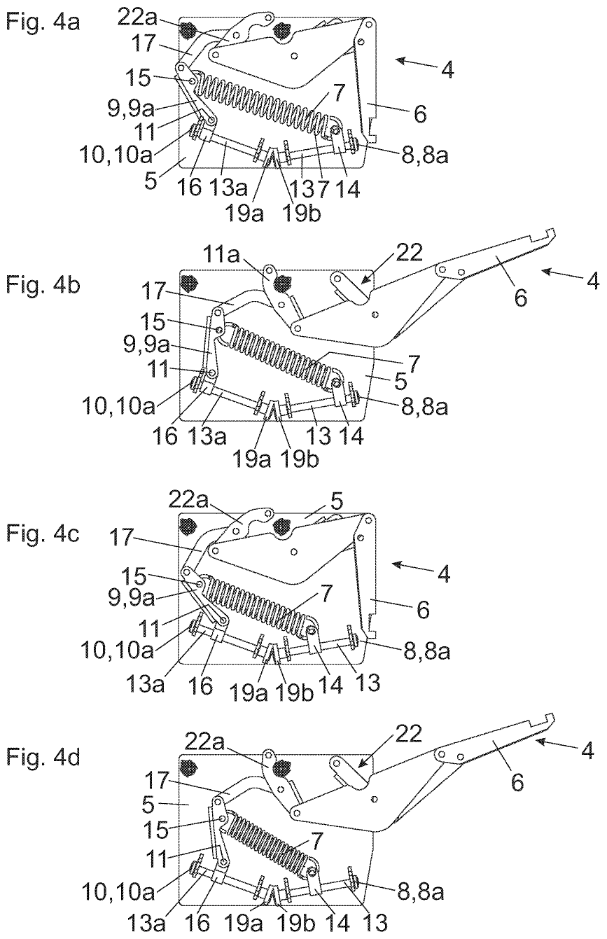

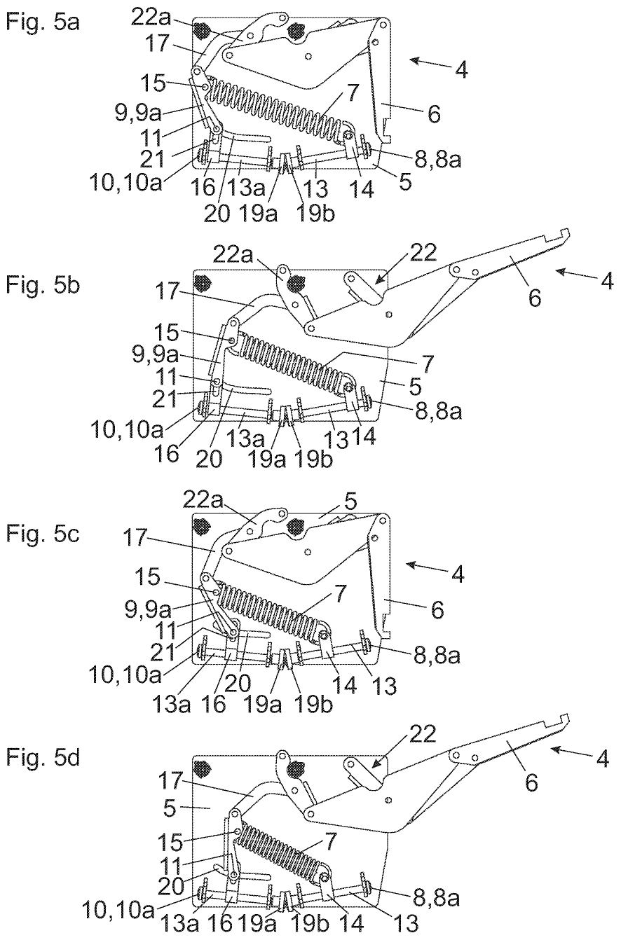

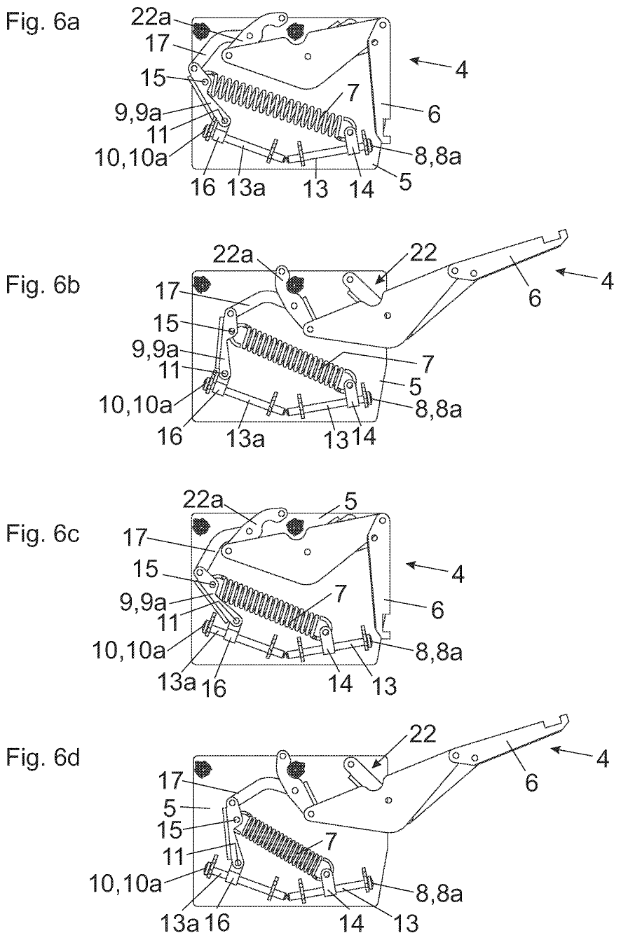

FIG. 5a-5d show a further embodiment of a fitting 4 with at least one guide track 20 for displaceably supporting the hinge axis 11 of the transmission lever 9a relative to the base body 5. FIG. 5a shows the fitting 4 with the actuating arm 6 located in a closed position.

The at least one guide track 20 can be formed or arranged on the base body 5 of the fitting 4. In this way, the hinge axis 11 is guidable along the guide track 20 in a defined manner with improved stability. In the shown embodiment, the bearing device 16 for movably supporting the hinge axis 11 includes at least one elongated hole 21, and the hinge axis 11 of the transmission lever 9a is movable along the guide track 20 of the base body 5 and along the elongated hole 21 of the bearing device 16.

The force adjustment device 8 for adjusting a torque to the at least one actuating arm 6 and the adjustment device 10 for adjusting a position of the hinge axis 11 are, as in the previous embodiment, coupled to each other via co-operating tooth arrangements 19a, 19b. Upon rotating one of the adjustment elements 8a, 10a, the other adjustment element 10a, 8a is also moved therewith. As a result, the two threaded spindles 13, 13a can be set into a rotational movement and the bearing devices 14, 16 are movable relative to each other.

Preferably, the relative distance between the two bearing devices 14, 16 can be decreased upon an actuation of the force adjustment device 8 and/or by an actuation of the adjustment device 10 so as to reduce a torque acting on the actuating arm 6.

FIG. 5b shows the fitting 4 according to FIG. 5a with the actuating arm 6 located in an open position.

FIG. 5c shows the fitting 4 according to FIG. 5a, 5b, in which by an actuation of the force adjustment device 8, both the pre-stressing force of the spring device 7 can be reduced and the position of the hinge axis 11 can be altered.

For guiding the hinge axis 11 relative to the base body 5, at least one guide track 20 can be provided. For example, the guide track 20 is partially curved and/or is formed directly in the base body 5.

Alternatively, the at least one guide track 20 can be configured as a separate component which is preferably arranged on the base body 5.

FIG. 5d shows the fitting 4 according to FIG. 5c with the actuating arm 6 located in an open position.

FIG. 6a-6d show a further embodiment of a fitting 4, in which the force adjustment device 8 and an adjustment device 10 independent of the force adjustment device 8 are provided for adjusting a position of the hinge axis 11 relative to the base body 5.

In other words, the two threaded spindles 13, 13a are no longer motionally coupled to each other here, but are rather movable independently from each other. This embodiment offers an individual adjustment of the pre-stressing force of the spring device 7 on the one hand, and an adjustment of the hinge axis 11 of the at least one transmission lever 9a on the other hand.

FIG. 6a shows the fitting 4 with the actuating arm 6 located in a closed position.

FIG. 6b shows the fitting 4 according to FIG. 6a with the actuating arm 6 located in an open position.

FIG. 6c shows the fitting 4 according to FIGS. 6a, 6b with the actuating arm 6 located in a closed position. By an actuation of the force adjustment device 8, the torque acting on the actuating arm 6 is adjustable. Independently of the force adjustment device 8, the adjustment device 10 can be actuated to adjust a position of the hinge axis 11 relative to the base body 5.

FIG. 6d shows the fitting 4 according to FIG. 6c with the actuating arm 6 located in an open position.

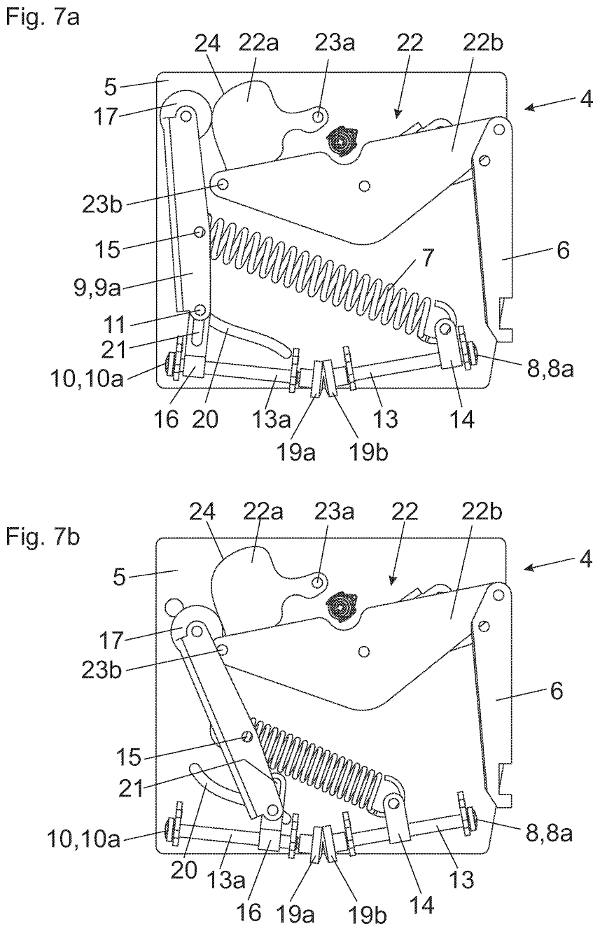

FIG. 7a and FIG. 7b show a further embodiment of a fitting 4, in which the transmission mechanism 9 includes at least one arrangement comprising a pressure roller and a control curve for pivoting the at least one actuating arm 6.

FIG. 7a shows the fitting 4 with the actuating arm 6 located in a closed position.

In the shown embodiment, the force adjustment element 17 pressurized by the spring device 7 is a rotatable pressure roller which, upon a movement of the actuating arm 6, is displaceable along a control curve 24 arranged or formed on the lever 22a.

This has the effect that the force exerted by the spring device 7 on the pivoting element 3 by means of the fitting 4 can be transmitted to the at least one actuating arm 6 in a dosed manner according to a predetermined course.

In the shown embodiment, the control curve 24 is formed or arranged on a lever 22a of the lever mechanism 22. The lever 22a is pivotally arranged about an axis 23a on the base body 5, and is pivotally connected to a further lever 22b of the lever mechanism 22 via an axis 23b.

In a kinematic reversal, it is also possible to arrange the control curve 24 on the force transmitting element 17 and to rotatably support the pressure roller on the lever 22a of the lever mechanism 22.

In the shown embodiment, the two threaded spindles 13, 13a are coupled to each other via co-operating tooth arrangements 19a, 19b, so that upon a rotational movement of one of the threaded spindles 13, 13a, the other threaded spindle 13, 13a is also rotated.

In this way, upon an actuation of an adjustment element 8a, 10a, the bearing devices 14, 16 are also movable along the threaded spindles 13, 13a, and the pre-stressing force of the spring device 7 to the actuating arm 6 and a closing force, that can be applied to the actuating arm 6 in the closed position by the spring device 7, are simultaneously adjustable.

For guiding the hinge axis 11 of the transmission lever 9a relative to the base body 5, at least one guide track 20 can be provided.

FIG. 7b shows the fitting 4 according to FIG. 7a, in which the positions of the bearing devices 14, 16 relative to the base body 5 are adjustable by an actuation of the force adjustment device 8 and/or by an actuation of the adjustment device 10.

At least one adjustment element 8a, 10a, preferably both adjustment elements 8a, 10a, can include at least one receiving contour for receiving a tool, for example a screwdriver. Upon rotating the adjustment elements 8a, 10a with the aid of a tool, the position of the spring device 7 and/or the position of the hinge axis 11 of the transmission lever 9a relative to the base body 5 of the fitting 4 is or are adjustable.

1. A fitting, configured as a furniture fitting or as a construction fitting, for movably supporting a pivoting element, in particular a movable furniture part, relative to a stationary structure, in particular a furniture carcass, the fitting comprising:
at least one base body to be fixed to the stationary structure,
at least one actuating arm to be connected to the pivoting element,
at least one spring device configured to apply a force to the at least one actuating arm, the spring device being supported on the at least one base body via at least one bearing device,
at least one transmission mechanism for transmitting a force of the at least one spring device to the at least one actuating arm, the transmission mechanism including at least one transmission lever pivotable about a hinge axis, and
at least one force adjustment device for adjusting a force of the spring device to the at least one actuating arm,
wherein at least one adjustment device, preferably separate from the at least one force adjustment device, is provided for adjusting a position of the at least one hinge axis of the at least one transmission lever relative to the base body.

2. The fitting according to claim 1, wherein the at least one force adjustment device and the at least one adjustment device include a common adjustment element or include at least two motionally coupled adjustment elements, preferably motionally coupled via at least one tooth arrangement, wherein by the common adjustment element or by the at least two motionally coupled adjustment elements, the force of the spring device to the at least one actuating arm and the position of the at least one hinge axis of the at least one transmission lever relative to the base body are simultaneously adjustable.

3. The fitting according to claim 1, wherein the at least one force adjustment device and the at least one adjustment device include two mutually independent adjustment elements, wherein the force of the spring device to the at least one actuating arm and the position of the at least one hinge axis of the at least one transmission lever relative to the base body are independently adjustable of one another by the two adjustment elements.

4. The fitting according to claim 2, wherein at least one of the provided adjustment elements includes at least one threaded spindle, and/or is directly accessible for an actuation from a front side of the fitting, and/or is aligned obliquely relative to an upper side and/or obliquely relative to a lower side of the at least one base body.

5. The fitting according to claim 1, wherein the spring device is connected to the at least one transmission lever via an engagement location, preferably wherein the engagement location is stationarily arranged relative to the transmission lever and/or wherein the engagement location is spaced apart from the hinge axis of the transmission lever.

6. The fitting according to claim 1, wherein the at least one transmission lever has a first end and a second end, wherein the hinge axis is arranged on the first end and wherein at least one force transmitting element, preferably a lever, a pressure portion, a pressure roller or a control curve, pressurized by the spring device is arranged on the second end.

7. The fitting according to claim 5, wherein the engagement location is arranged between the first end and the second end of the transmission lever.

8. The fitting according to claim 1, wherein at least one bearing device for supporting the spring device and/or for supporting the at least one hinge axis on the base body is provided, wherein a position of the bearing device relative to the base body is adjustable by the at least one force adjustment device and/or by the at least one adjustment device.

9. The fitting according to claim 8, wherein a first bearing device for supporting the at least one hinge axis and a second bearing device for supporting the spring device are provided, preferably wherein the two bearing devices are movably arranged on a common threaded spindle or on at least two threaded spindles motionally coupled to each other, preferably motionally coupled via at least one tooth arrangement, or on two mutually independent spindles.

10. The fitting according to claim 8, wherein at least one of the bearing devices includes at least one elongated hole for guiding the hinge axis of the at least one transmission lever.

11. The fitting according to claim 1, wherein by the at least one force adjustment device, a pre-stressing force of the at least one spring device is adjustable so as to compensate for different weights of a pivoting element to be connected to the actuating arm.

12. The fitting according to claim 1, wherein the at least one actuating arm is movably supported between a closed position and an open position, wherein by the adjustment of the position of the at least one transmission lever, a closing force, that can be applied to the actuating arm by the spring device in the closed position, is adjustable.

13. The fitting according to claim 1, further comprising at least one guide track, wherein the hinge axis of the transmission lever is displaceable along the guide track by the force adjustment device and/or by the adjustment device.

14. The fitting according to claim 1, wherein the fitting includes a lever mechanism, preferably having at least seven hinge axes, by which the at least one actuating arm is movably supported on the base body.

15. An item of furniture comprising:
a stationary structure, in particular a furniture carcass,
at least one pivoting element, in particular a movable furniture part, movably-supported relative to the stationary structure, and
the fitting according to claim 1 for moving the pivoting element relative to the stationary structure.
